(19) United States
(12) Patent Application Publication
(10) Pub. No.: US 2023/0097770 A1
(43) Pub. Date: Mar. 30, 2023

(54) AUTHORIZATION MONITOR TO DETECT PRIVILEGE USAGE PATTERNS

(71) Applicant: VMware, Inc., Palo Alto, CA (US)

(72) Inventors: Elena DIMITROVA, Sofia (BG); Georgi LEKOV, Sofia (BG); Radoslav GANKOV, Sofia (BG); Yoana STOYANOVA, Sofia (BG); Ivaylo KIRYAZOV, Sofia (BG)

(21) Appl. No.: 17/489,012

(22) Filed: Sep. 29, 2021

(51) Int. Cl. H04L 29/06

(52) U.S. Cl. CPC H04L 63/1425; H04L 63/10; H04L 63/1416; H04L 63/20

(57) ABSTRACT

The disclosure herein describes monitoring authorization checks and detecting excess authorization privileges and other privilege usage patterns. An authorization check associated with an operation performed during a session in a computing environment is captured and a set of authorization privileges granted to a user of the session is identified. Based on comparison of the authorization privileges to authorization checks including the captured authorization check, excess authorization privileges granted to the user of the session is detected, wherein the excess authorization privileges are a subset of the identified set of authorization privileges. A privilege discrepancy notification based on the detected set of excess authorization privileges is generated. The detected privilege usage patterns described herein are used to improve the efficient use, and increase the security, of resources in the computing system. Further, the time required for authorization processing is reduced through caching of frequent privilege usage patterns.

### BACKGROUND

Modern, large-scale distributed computing systems offer customers a plethora of application program interfaces (APIs) empowering them to create their own virtual ecosystems with automated workflows. With so many possible use cases, some customers use the systems in unforeseen ways, creating suboptimal, insecure, erroneous, or otherwise inefficient workflows or configurations. Such workflows can be crippling to the customers and the system itself because they may be the result of undiscovered software bugs or malicious parties attempting to find vulnerabilities. Traditional test design specifications cannot cover the innumerable permutations of workflows that customers can attempt, so it is a challenge for administrators of such systems to maintain security and efficiency while ensuring the flexibility of the system for use by customers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for monitoring authorization checks and detecting excess authorization privileges of a session is described. An authorization check associated with an operation performed during a session of a user in a computing environment is captured and a set of authorization privileges granted to the user during the session is identified. Based on comparison of the set of authorization privileges to a set of authorization checks including the captured authorization check, a set of excess authorization privileges granted to the user during the session is detected, wherein the set of excess authorization privileges is a subset of the identified set of authorization privileges. Then, a privilege discrepancy notification based on the detected set of excess authorization privileges is generated.

### BRIEF DESCRIPTION OF THE DRAWINGS

The present description will be better understood from the following detailed description read in light of the accompanying drawings, wherein:

FIG. 1 is a diagram illustrating an example virtualized computing environment that can implement authorization monitoring and detection of privilege usage patterns;

FIG. 2 is a block diagram illustrating a system configured to monitor authorization checks of sessions;

FIG. 3 is a flowchart illustrating a computerized method for monitoring authorization checks and detecting excess authorization privileges of a session;

FIG. 4 is a flowchart illustrating a computerized method for storing authorization check results and providing stored results in response to authorization checks;

FIG. 5 is a flowchart illustrating a computerized method for monitoring authorization checks and identifying inaccessible resources based on the authorization checks; and

FIG. 6 illustrates a computing apparatus as a functional block diagram.

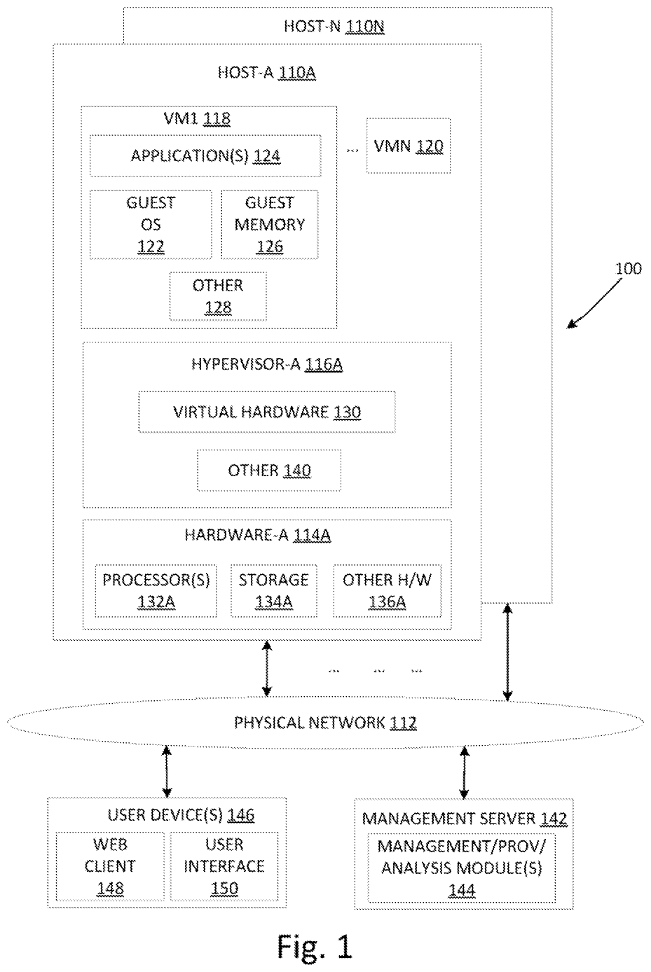

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a computerized method and system for monitoring authorization checks and detecting excess authorization privileges and other privilege usage patterns of a session. Authorization checks associated with a session can indicate information about the operations, tasks, and/or workflows being performed during the session. By capturing and analyzing authorization checks during operation of the system, inefficiencies and vulnerabilities can be identified and corrected. Further, caching information about authorization checks and associated pattern recognition can be used to improve the efficiency of authorization processes of the system. For instance, for a session, a set of granted authorization privileges is identified and based on a set of authorization checks, a set of excess authorization privileges granted to a user during the session is detected. A privilege discrepancy notification based on the detected set of excess authorization privileges is generated. The notification is provided to a user or to an automated tool, enabling the user or automated tool to take action to correct the excess authorization privileges (e.g., the user or automated tool reduces the privileges granted to the session and/or the user of the session to a minimum set of needed privileges to improve security).

The disclosure operates in an unconventional manner at least by tracking authorization checks for application programming interface (API) invocations along with session information, current privileges granted to users of the sessions, the resources being accessed, and the minimum set of privileges required to perform desired operations. When the authorization checks for operations are logged and filtered to detect usage patterns (e.g., to detect a very high-privileged session routinely not using its privileges), inefficient or insecure configurations are identified. The disclosure further provides notification of inefficient, erroneous, or suspicious behavior, enabling clients or administrators to be proactive in handling unfavorable issues.

Further, the authorization monitoring and auditing of the disclosure enable the optimization of performance of frequent operations and/or workflows. If it is evident that the same pattern of authorization checks is performed frequently for a workflow, the disclosure enables authorization check results to be cached in order to reduce the time and processing necessary to perform those authorization checks each time.

The disclosure further enhances detection of coverage (e.g., code coverage) of system resources. By analyzing the recorded authorization checks as described herein, the creation and use of expensive and cumbersome builds to detect coverage are avoided. This reduces processing time and memory resource usage. The captured authorization checks can be used to quickly track accessed APIs and resource access, providing certainty of code coverage and correctness with respect to those resources. This accelerates the internal development process with reduced computing resource usage and enables the development of insights to help customers improve the speed, efficiency, and other factors of their own code.

The disclosure improves the efficiency of computing systems with respect to authorization and privilege processing to enable operations of sessions and associated users to access secure system resources. By capturing authorization checks and results, caching them, and detecting privilege usage patterns that match the cached results, the disclosure can quickly and efficiently respond to authorization checks of those patterns and avoid relatively more resource-expensive authorization check processes.

The disclosure further improves computing systems at least by enabling system administrators or automated tools to identify abnormal privilege usage patterns that indicate suboptimal operations, malicious operations, erroneous operations, or other undesirable operations. The administrators or automated tools are enabled to take proactive steps to fix or stop the abnormal privilege usage patterns, freeing up those system computing resources and reducing the overall computing resource load of the system.

In some examples, the technology described herein is implemented in a virtualized computing environment. Virtualization allows the abstraction and pooling of hardware resources to support virtual machines (VMs) in a virtualized computing environment, such as a software-defined datacenter (SDDC). For example, through server virtualization, VMs running different operating systems are supported by the same physical machine (e.g., referred to as a “host”). Each VM is generally provisioned with virtual resources to run an operating system and applications. The virtual resources may include central processing unit (CPU) resources, memory resources, storage resources, network resources, etc.

While described with reference to VMs in some examples, aspects of the disclosure are operable with other virtualized computing instances or compute entities such as containers.

Various implementations will now be explained in more detail using FIG. 1, which is a schematic diagram illustrating an example virtualized computing environment 100 that can implement authorization monitoring and detection of privilege usage patterns. Depending on the desired implementation, virtualized computing environment 100 may include additional and/or alternative components than that shown in FIG. 1.

Generally speaking, a workflow in the virtualized computing environment 100 can involve a set of actions, which can be sequential, out-of-order, branching, etc., that are performed to initiate and complete a task. For example, the task involves the configuration of certain subsystems, devices, and/or elements in the virtualized computing environment 100. Other example tasks involve troubleshooting, maintenance, provisioning, monitoring, and various other tasks that pertain to the management or use of the various subsystems, devices, and/or elements in the virtualized computing environment 100. The workflows are performed by a system administrator, other IT staff member, or any other user (e.g., human or machine or software entities) or combination thereof in the virtualized computing environment 100.

In the example in FIG. 1, the virtualized computing environment 100 includes multiple hosts, such as host-A 110A to host-N 110N that are configured to be interconnected via a physical network 112. Examples of the physical network 112 include a wired network, a wireless network, the Internet, or other network types and/or combinations of different networks and network types. For simplicity of explanation, the various components and features of the hosts will be described hereinafter in the context of host-A 110A. Each of the other host-N 110N include substantially similar components and features.

The host-A 110A includes suitable hardware-A 114A and virtualization software (e.g., hypervisor-A 116A) to support various VMs. For example, the host-A 110A supports VM1 118 to VMN 120. In practice, the virtualized computing environment 100 can include any number of hosts (also known as “computing devices”, “host computers”, “host devices”, “physical servers”, “server systems”, “physical machines,” etc.), wherein each host can support tens or hundreds of VMs. For the sake of simplicity, the details of only the single VM1 118 are shown and described herein.

In some examples, VM1 118 includes a guest operating system (OS) 122 and one or more guest applications 124 (and their corresponding processes) that run on top of the guest operating system 122. VM1 118 also includes a guest memory 126 for use by the guest operating system 122 and/or for other storage purposes. Additionally, in some examples, VM1 118 includes still further other elements, generally depicted at 128, such as a virtual disk and/or other elements usable in connection with operating VM1 118.

In some examples, the hypervisor-A 116A is a software layer or component that supports the execution of multiple virtualized computing instances. The hypervisor-A 116A runs on top of a host operating system (not shown) of the host-A 110A or runs directly on hardware-A 114A. The hypervisor-A 116A maintains a mapping between underlying hardware-A 114A and virtual resources (depicted as virtual hardware 130) allocated to VM1 118 and the other VMs. Additionally, or alternatively, the hypervisor-A 116A includes still further elements 140 to support operation of the hypervisor-A 116A and its associated VMs.

Hardware-A 114A in turn includes suitable physical components, such as CPU(s) or processor(s) 132A; storage device(s) 134A; and other hardware 136A such as physical network interface controllers (NICs), storage disk(s) accessible via storage controller(s), etc. Virtual resources (e.g., the virtual hardware 130) are allocated to each VM to support a guest operating system (OS) and application(s) in the VM, such as the guest OS 122 and the applications 124 in VM1 118. Corresponding to the hardware-A 114A, the virtual hardware 130 includes a virtual CPU, a virtual memory, a virtual disk, a virtual network interface controller (VNIC), and more.

A management server 142 in one example takes the form of a physical computer with functionality to manage or otherwise control the operation of host-A 110A . . . host-N 110N. In some examples, the management server 142 is operable to collect usage data associated with the hosts and VMs, to configure and provision VMs, to activate or shut down VMs, to monitor and remedy network problems or other operational issues, and to perform other managerial tasks associated with the operation and use of the various elements in the virtualized computing environment 100. The management server 142 is a physical computer that provides a management console and other tools that are directly or remotely accessible to a system administrator or other user having the appropriate privilege(s).

Further, in some examples, the management server 142 includes one or more modules 144 that are usable for tasks that pertain to resource management, provisioning, analysis, etc. Such modules can be embodied as software programs or other code or tools, including some associated hardware. For example, one of the modules 144 includes a provisioning module for the provisioning and management of VMs. Another example of the modules 144 includes a resource management module for the management of resources (e.g., hardware and software resources) in the virtualized computing environment 100. Still another example of the modules 144 includes a data analysis module for the analysis of resource usage data associated with hosts and VMs. These are only a few examples of the modules 144 that can be included in the management server 142.

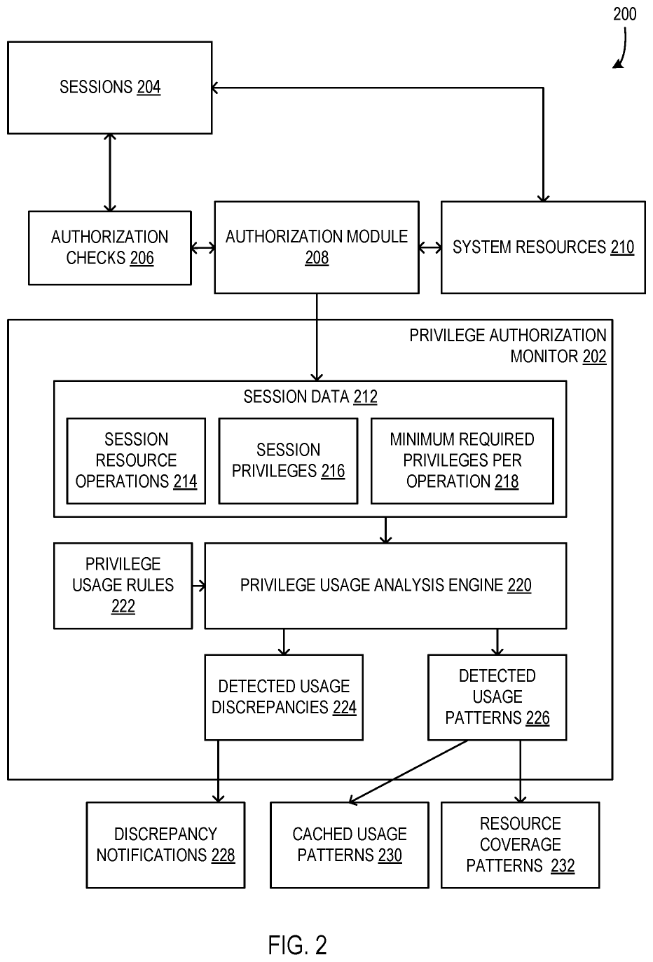

In some examples, the functionality and features of the modules 144 are accessible by a system administrator (or other user having the appropriate privileges) through one or more APIs that are invoked during a workflow, or outside of a workflow. Further details about how such APIs are used to monitor authorization checks and detect excess privileges and/or other privilege usage patterns, as well as further details about the various other elements of the management server 142, are provided herein with respect to FIGS. 2-5.

In some examples, the management server 142 is communicatively coupled to host-A 110A to host-N 110N (and hence communicatively coupled to the VMs, hypervisors, hardware, etc.) via the physical network 112. The host-A 110A to host-N 110N is in turn configured as a datacenter that is also managed by the management server 142. In some examples, the functionality of the management server 142 is implemented in any of host-A 110A to host-N 110N, instead of being provided as a separate standalone device such as depicted in FIG. 1.

In some examples, a user operates a user device 146 to access, via the physical network 112, the functionality of VM1 118 to VMN 120, using a web client 148. The user device 146 can be in the form of a computer, including desktop computers and portable computers (such as laptops and smart phones). In one example, the user is a system administrator that also uses the web client 148 of the user device 146 to remotely communicate with the management server 142 for configuring, managing, etc. the VMs and hosts. For example, the user uses the web client 148 to initiate and execute a workflow. The web client 148 then uses APIs to perform API calls to access the functionality of the modules 144 and/or other resources provided through the management server 142. In some examples, other tools in the user device 146 can be used, alternatively or in addition to the web client 148, to initiate and execute a workflow. For example, an application (different from the web client 148) installed in the user device 146 can be used to interact with the management server 142, including using APIs to make API calls to the management server 142.

Further, in some examples, the user device 146 also includes a user interface 150. The user interface 150 comprises part of the web client 148 (e.g., a web-based user interface), or is external to the web client 148 (such as a user interface that is provided by some other application installed in the user device 146 and which can communicate with the web client 148). The web client 148 in an example is in turn any suitable browser-based application that is capable to communicate with the management server 142 (or other remote device), to generate the user interface 150 (including providing workflow tools and data via the user interface 150), and to support other functionality for operating the user device 146. The features and functionality of various elements of the user device 146, in the context of using the disclosed methods and systems, is further described with respect to FIGS. 2-5.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

FIG. 2 is a block diagram illustrating a system 200 configured to monitor authorization checks 206 of sessions 204. The system 200 includes a privilege authorization monitor 202 that collects session data 212 from an authorization module 208 of the system 200, including data associated with authorization checks 206 initiated during the sessions 204. The privilege authorization monitor 202 is configured to monitor and/or audit the privilege usage of sessions 204 in the system 200 as described herein. In some examples, the sessions 204 are periods of communication between the system 200 and another system and sessions 204 are associated with instances of applications or programs that use system resources 210, wherein each session 204 has an associated set of access privileges and/or permissions (e.g., session privileges 216) to those system resources 210. Sessions 204 are started and/or used by users and/or automated processes, and the session privileges 216 of the sessions 204 are based on, at least in part, privileges granted to those users and/or automated processes. In examples where a user has a set of granted privileges and the user uses multiple sessions 204 over time, each of the user's sessions 204 has session privileges 216 based on the privileges granted to the user (e.g., based on an identifier of the user, a role or other classification of the user, or the like). Further, in some examples, the system 200 is part of a system such as system 100 of FIG. 1, such that the privilege authorization monitor 202 monitors and/or audits the authorizations associated with resources of the system 100 that are accessed by user devices 146.

In some examples, the sessions 204 are configured to enable performance of operations that include requests to access system resources 210 by the other systems of the sessions 204. Requests to access those system resources 210 include authorization checks 206 sent to the authorization module 208. In such examples, the authorization module 208 is configured to evaluate the authorization checks 206 to determine whether a session 204 has privileges to access a requested system resource 210. It should be understood that authorization checks 206 are also called privilege checks in some examples. The authorization checks 206 include identifying information, such as a session identifier, a user identifier, a user role identifier, or the like. The authorization module 208 uses the identifying information of the authorization check 206 to determine the privileges granted to one or more users of the session 204 and, based on those determined privileges, the authorization module 208 determines whether an operation during the session 204 is granted access to the requested system resources 210. Additionally, or alternatively, the authorization checks 206 are triggered by or otherwise based on the invocation of APIs during the session 204. Such APIs are defined and/or configured to enable access to the system resources 210 (e.g., a data storage API enabling operations during a session 204 to write data to a data storage resource 210 triggers an authorization check 206 that determines whether the session 204 has a session privilege 216 granting operations during the session 204 permission to write to the data storage resource 210).

In examples where an operation during a session 204 is granted access to the requested system resources 210 by the authorization module 208, the operation of the session 204 is enabled to use the requested system resources 210. In some examples, the requested system resources 210 include data storage resources, computation or processing resources, or the like. For instance, an operation of a session 204 requests to write data to data storage resources and/or read data from data storage resources. Alternatively, or additionally, the operation of the session 204 requests to use processing resources to execute a script, application, or other program. Further, in some examples, system resources 210 include objects, applications or programs, and/or APIs configured to access other system resources 210. For instance, a user of a session 204 is granted a session privilege that gives an operation of the session 204 permission to make an API call that uses one or more other system resources 210.

Further, in examples where a session 204 is denied access to the requested resources 210 by the authorization module 208, an operation during the session 204 is prevented from using the requested system resources 210. The denial of access is provided to the session 204 by the authorization module 208. In some examples, such a denial of access includes an indication of the system resource for which the session 204 lacks a privilege and/or an indication of a particular privilege that the session 204 lacks.

In some examples, the system includes a cloud computing platform that includes distributed computing devices that offer wide varieties of data storage resources and processing resources. For instance, in such a cloud computing platform, sessions 204 are used to store data to data storage resource in the cloud and then to access that data from other locations through sessions 204. Additionally, or alternatively, in such a cloud computing platform, sessions 204 are used to create VMs (e.g., VM1 118-VMN 120 of FIG. 1) or other virtual computing instances (VCIs) on the platform that the sessions 204 can used for executing or otherwise performing applications or other programs.

Further, when the authorization module 208 receives an authorization check 206, it provides data of the authorization check 206 to the privilege authorization monitor 202. The privilege authorization monitor 202 stores the received data of the authorization check 206 in association with the session 204 as session data 212. The session data 212 includes session resource operations 214, session privileges 216, and minimum required privileges per operation 218. Further, the session data 212 of a session 204 is stored with a session identifier of the session 204. In some examples, the session data 212 of the session 204 is stored with other identifying information, such as a user identifier and/or a user role identifier.

In some examples, the session resource operations 214 include data associated with operations, tasks, and/or workflows performed during a session 204 that result in authorization checks 206. Each operation performed during the session 204 that results in authorization checks 206 is collected by the privilege authorization monitor 202 and stored in association with the session 204. Each session resource operation 214 recorded in the session data 212 includes at least one authorization check 206, though in many instances, a session resource operation 214 includes ten or more authorization checks 206. In an example where operations of the session 204 are associated with a graphical user interface (GUI) with buttons that cause complex operations to be performed, those operations cause hundreds of authorization checks 206 to be performed due to the quantity of different system resources 210 being accessed or otherwise affected by the operations. Additionally, each authorization check 206 of a session resource operation 214 is associated with a privilege that is required to gain access to the requested system resource 210. In some examples, those required privileges are also stored with the session resource operations 214 of the session data 212.

In some examples, the session privileges 216 include privileges and/or permissions granted to the user(s) of the session 204 based on the session identity, the user identity of the user of the session, the user role or other classification of the user of the session, or the like. Those session privileges 216 are representative of the limits to which operations during the session 204 can access the system resources 210. In an example, the user of the session 204 has a role and that role grants the user of the session 204 a set of privileges that enable operations during the session 204 to access system resources 210 associated with that role. Additionally, or alternatively, the user has a set of privileges granted to them that are specific to the user that further expand the system resources 210 to which operations of the session 204 are granted access. Further, in some examples, other privileges 216 are associated with the session 204 that are specific to the session 204, specific to a session type of the session 204, or granted to user of the session 204 for other reasons without departing from the description.

In some examples, the session data 212 includes minimum required privileges per operation 218. The minimum required privileges per operation 218 are calculated or otherwise determined based on the session resource operations 214 of the session data 212 and the authorization checks 206 associated with those operations 214. The privilege authorization monitor 202 is configured to determine a minimum required privilege 218 of an operation 214 by identifying each authorization check 206 of the operation 214 and creating a list or set of privileges that are necessary to satisfy each of the identified authorization checks 206. Further, duplicate privileges in the set of privileges are removed, resulting in a set of the minimum required privileges 218 for the associated operation 214. If the session privileges 216 of a session 204 include all the privileges in the minimum required privileges 218 of an operation 214, the session 204 has sufficient privileges 216 for the operation 214 to be fully performed.

The privilege authorization monitor 202 includes a privilege usage analysis engine 220 and associated privilege usage rules 222. In some examples, the engine 220 and rules 222 are configured to analyze the session data 212 of sessions 204 and to detect patterns and or discrepancies in privilege usage during those sessions 204 based on the analysis. For instance, the engine 220 analyzes the minimum required privileges per operation 218 and session privileges 216 of the session data 212 of the session 204 to detect usage discrepancies 224 (e.g., when a session 204 has session privileges 216 that are unnecessary for any of the session resource operations 214 of the session 204).

In such examples, privilege usage rules 222 are defined that are evaluated by the engine 220 with respect to the session data 212 to determine whether a usage discrepancy 224 is detected. For instance, a privilege usage rule 222 is defined that indicates that a usage discrepancy 224 is detected when operations during a session 204 do not use a session privilege 216 granted to a user of the session 204. Additionally, or alternatively, privilege usage rules 222 are defined that further expand or limit how usage discrepancies 224. In such an example, a privilege usage rule 222 is defined that indicates that a usage discrepancy 224 is detected when operations during a session 204 fail to use a session privilege 216 for a defined period of time (e.g., one day, one week, one month, or the like). Additionally, or alternatively, a privilege usage rule 222 is defined that indicates that a usage discrepancy 224 is detected when operations during a session 204 fail to use a quantity or percentage of session privileges 216 (e.g., a usage discrepancy is detected when a session fails to use ten or more session privileges, or 10% or more of the total session privileges of that session).

In examples where session privileges 216 of a session 204 are associated with a user of the session 204, the privilege usage analysis engine 220 is configured to analyze session data 212 of multiple sessions 204 with which that user is associated to detect usage discrepancies 224 and/or usage patterns 226 (e.g., sets of authorization checks that occur in association with an operation, task, or workflow of a session) as described herein. For instance, privilege usage rules 222 are defined that indicate that usage discrepancies 224 are detected in association with a user based on the sessions 204 of the user failing to use session privileges over a defined time period (e.g., if a user fails to use a granted session privilege over the course of a week), over a quantity of sessions 204 (e.g., if a user fails to use a granted session privilege during the use of three sessions), and/or for a defined quantity or percentage of session privileges (e.g., if a user fails to use ten or more granted session privileges). In other examples, more, fewer, or different types of privilege usage rules 222 are used to define how usage discrepancies 224 are detected without departing from the description herein.

In some examples, the detected usage discrepancies 224 are used to generate discrepancy notifications 228 as output of the privilege authorization monitor 202. Such discrepancy notifications 228 are sent to a system administrator or other user of the system such that the discrepancies 224 can be addressed. For instance, if detected usage discrepancies 224 indicate that a user has several granted privileges that they never use, a discrepancy notification 228 is generated that indicates that the user has excess privileges and the privileges that are determined to be in excess. In some examples, such a discrepancy notification 228 is provided to a device and displayed on a user interface for observation by a user. Alternatively, or additionally, the discrepancy notification 228 is provided to an API associated with an application that is configured to process the discrepancy notification 228 (e.g., the discrepancy notification 228 is analyzed and a recommended action to be taken is generated and provided to a system administrator, such as a recommendation to remove some or all of the detected excess privileges). Further, in some examples, the discrepancy notifications 228 identify user roles or other groups or classifications of users that have excess granted privileges without departing from the description.

Further, the privilege usage analysis engine 220 is configured to detect usage patterns 226 during a session 204 or sessions 204 based on session data 212 and/or on the defined privilege usage rules 222. In some examples, the detected usage patterns 226 are defined based on associated privilege usage rules 222 and the engine 220 is configured to detect when sessions 204 use session privileges 216 according to those defined usage patterns 226. Such usage patterns 226 are used to detect more general patterns of operation of sessions 204 and/or to trigger events or actions by the privilege authorization monitor 202.

Additionally, or alternatively, the privilege usage analysis engine 220 is configured to detect new usage patterns 226 that occur. In some examples, the engine 220 analyzes session data 212 of multiple sessions 204 and/or sessions 204 over a time period and detects when sessions 204 use privileges 216 in the same or similar patterns 226. Detecting such new patterns enables the privilege authorization monitor 202 to trigger events or actions based on detecting the same or similar patterns 226 later with respect to the same or different sessions 204. Some possible patterns to be detected include patterns of common session operation that can be cached (e.g., as cached usage patterns 230) or otherwise made more efficient when those operations occur in the future, and/or patterns associated with fraudulent or otherwise improper session operation that can be detected and stopped or otherwise prevented.

In some examples, the frequently detected usage patterns 226 are stored as cached usage patterns 230, such that those cached usage patterns 230 can be used to improve the efficiency of the system 100 and/or to improve the efficiency of the authorization module 208 specifically. In such examples, the performance of authorization checks 206 by the authorization module 208 requires some time and processing resources to complete. Cached usage patterns 230 are used to reduce the total time and/or processing requirements of those authorization checks 206 by storing information that can be provided efficiently to the authorization module 208. Upon receiving data (e.g., authorization check results from previous checks of the cached usage patterns 230) associated with the cached usage patterns 230, the authorization module 208 is enabled to reduce the quantity of processing it would typically perform to determine that received data via conventional processing. Alternatively, or in addition, aspects of the disclosure include a cache invalidation mechanism, which detects changes to permissions and removes impacted cached usage patterns from the cache.

In an example of using cached usage patterns 230, a user X of a session queries a system resource Y for a privilege P. This query is recorded as a cached usage pattern and, if the query is made again, the cached result of the query is used and at least a portion of the convention query process is avoided based on using the cached result. The cache invalidation mechanism is configured to track changes to granted permissions and/or privileges and, if those changes affect an aspect of a cached usage pattern 230, that cached usage pattern 230 is invalidated and/or removed from the cache. For instance, assume that the following patterns 230 are cached: user X1 querying resource Y1 for privilege P1; user X2 querying resource Y1 for privilege P2; and user X1 querying resource Y2 for privilege P3. In this example, if permissions for user X1 are changed, the first and third cached usage patterns 230 are invalidated.

Further, in some examples, the detected usage patterns 226 include patterns that are indicative of whether a resource is accessible to sessions 204. When new resources are included in the system resources 210 and/or privilege configurations are changed in some way, it is possible that some system resources 210 are rendered inaccessible. For instance, a new system resource 210 is added to the system 200 and associated with a new privilege that is required to access the new system resource 210, but the new privilege is not granted to any users or user roles due to error. In such example, detected usage patterns 226 from a variety of sessions 204 over time indicate that the new privilege is never being checked and that the new system resource 210 is inaccessible based on the privilege configuration. Such detected usage patterns 226 are output by the privilege authorization monitor 202 as resource coverage patterns 232 that can be provided to a system administrator or other user of the system, such that they can correct the inaccessibility issue.

Additionally, or alternatively, in some examples, detected usage patterns 226 are used to detect malicious operations or otherwise abnormal operations during session 204. In such examples, privilege usage rules are defined that indicate known usage patterns associated with legitimate operations (legitimate usage patterns) and/or known usage patterns associated with malicious operations (malicious usage patterns). If the detected usage patterns 226 match or otherwise are sufficiently similar to privilege usage rules of legitimate usage patterns (e.g., a detected usage pattern shares 95% of authorization checks with a legitimate usage pattern), those detected usage patterns 226 are considered legitimate usage patterns and no action is taken. Alternatively, if the detected usage patterns 226 match or otherwise are sufficiently similar to privilege usage rules of malicious usage patterns, those detected usage patterns 226 are considered malicious usage patterns and corrective action is taken (e.g., a system administrator is notified of the malicious operations, the session is temporarily or permanently locked out of the system, or the like).

Further, in some examples, detected usage patterns 226 that differ substantially from privilege usage rules 222 that are associated with known legitimate usage patterns, the detected usage patterns 226 are flagged for further analysis. For instance, the flagged usage patterns and data associated with the session, such as user identifier, user role identifier, date and time information, or the like, are provide to a system administrator to enable the administrator to determine if the detected activity is legitimate or abnormal. The receiver of this notification is further enabled to classify the detected usage pattern as legitimate or abnormal and to create one or more privilege usage rules 222 for identifying similar future usage patterns and handling those associated sessions 204 appropriately (e.g., if the detected usage pattern is classified as malicious, new rules are created such that future usage patterns that match are treated as malicious operations and stopped by the system).

In some examples, instead of or in addition to the privilege usage rules 222 used by the privilege usage analysis engine 220, the system 200 includes a privilege usage model that is trained to identify and/or classify privilege usage patterns using machine learning techniques. Such a model is trained using past sets of authorization checks and classified patterns in those authorization checks as training data. The model is trained to detect usage discrepancies 224 as described herein. Additionally, or alternatively, the model is trained to detect other usage patterns 226. In further examples, the model is updated using feedback from discrepancy notifications 228 or other notifications or output from the privilege authorization monitor 202, such that the model is improved over time as it is used.

In some examples, the model is trained using machine learning techniques that use, for instance, a trained regressor such as a random decision forest, a directed acyclic graph, a support vector machine, a convolutional neural network, or other neural network, or another trained regressor. Additionally, or alternatively, the training of the model makes use of training data described above when applying machine learning techniques and/or algorithms. In some examples, millions of training data pairs (e.g., a dataset of collected past data and/or a synthetic dataset) are stored in a machine learning data structure (e.g., of the system 200) for use in training the model and/or other trained models as described herein.

Further, in examples with such a model trained by machine learning techniques, the models are trained to detect usage patterns that are associated with malicious and/or erroneous activity. In such examples, the model is configured to generate notifications associated with such activity and/or to remove privileges from sessions that are associated with such activity until the associated issues can be resolved. The detected usage patterns may be refined during operation of the system, such that the detection of the malicious activity is improved. For instance, the model is trained over time to detect the malicious activity more quickly or earlier.

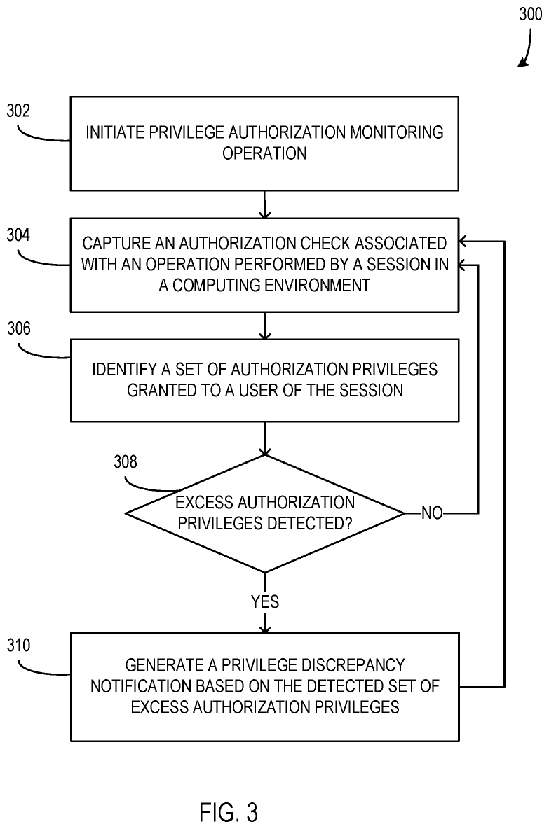

FIG. 3 is a flowchart illustrating a computerized method 300 for monitoring authorization checks (e.g., authorization checks 206) and detecting excess authorization privileges (e.g., detected usage discrepancies 224) of a session (e.g., a session 204). In some examples, the method 300 is executed or otherwise performed in a system such as systems 100 and 200 of FIGS. 1 and 2 respectively. For instance, the method 300 is performed by the privilege authorization monitor 202 of system 200 in FIG. 2. At 302, a privilege authorization monitoring operation is initiated and, at 304, an authorization check is captured, wherein the authorization check is associated with an operation performed during a session in a computing environment (e.g., a request for access to a resource of the computing environment, such as a processing resource, a data storage resource, and/or a system administration resource). In some examples, the authorization check is captured by a privilege authorization monitor from an authorization module as described herein. Additionally, or alternatively, the capture process includes the monitor requesting authorization checks from the module and/or the module providing the authorization checks to the monitor. In other examples, other methods of capturing the authorization checks are used without departing from the description (e.g., the system is configured to route authorization checks to both the authorization module and the privilege authorization monitor).

At 306, a set of authorization privileges (e.g., the session privileges 216) that have been granted to the session are identified (e.g., the authorization privileges granted to a user of the session). In some examples, the privilege authorization monitor collects the authorization privileges granted to the session as session data (e.g., session data 212) from the authorization module as described herein.

At 308, if excess authorization privileges are detected, the process proceeds to 310. Alternatively, if excess authorization privileges are not detected, the process returns to 304 to continue capturing authorization checks. Further, in some examples, the process ends or is suspended until there are additional authorization checks to capture.

In some examples, the detection of excess authorization privileges or other usage discrepancies are based on defined privilege usage rules (e.g., privilege usage rules 222). For instance, a privilege usage rule is defined that compares the set of privileges granted to the user of the session to a set of captured authorization checks from operations of that session and, if any granted privileges are not used in the set of captured authorization checks, those unused privileges are considered to be detected excess authorization privileges. Additionally, or alternatively, the privilege usage rules include additional details. Such additional details include a defined period of time during which the authorization checks of the session are captured (e.g., authorization checks from one hour or one day of session operations are compared to the granted privileges), a defined minimum quantity of captured authorization checks (e.g., excess authorization privileges are only detected based on capturing at least 1000 authorization checks during the session).

At 310, a privilege discrepancy notification (e.g., a discrepancy notification 228) is generated based on the detected set of excess authorization privileges. In some examples, the privilege discrepancy notification includes an identifier of the session and/or an identifier of a user of the session that has been granted the excess authorization privileges. Further, the generated privilege discrepancy notification is provided to a user of the privilege authorization monitor system and/or it is logged in the system for future viewing or processing.

Additionally, or alternatively, in some examples, the privilege usage rules are defined to detect excess authorization privileges of a user of the session. The set of captured authorization checks used are associated with a plurality of sessions of the user over a time period. The granted privileges used are those privileges that are granted to the user specifically based on the user's identity, role, or other classification. In such cases, a generated discrepancy notification includes identification of the user as being granted the detected set of excess authorization privileges.

Further, in some examples, the privilege usage rules are defined to detect malicious or otherwise abnormal operations of session. Such privilege usage rules are used to detect a privilege usage pattern that is indicative of a malicious operation being performed during the session. In response to the detected malicious operation, a malicious operation notification is generated indicating that the malicious operation is being performed during the session. Additionally, or alternatively, such a notification also triggers the system to end the session or otherwise prevent the session from accessing further resources until the malicious operation issue is resolved. In some examples, a privilege usage pattern indicative of a malicious operation includes a set of authorization checks associated with a known malicious operation, such as an exploit of the system to gain access to resources that would otherwise be inaccessible to the session. Additionally, or alternatively, a malicious operation may be indicated based on many repeated attempts to access resources for which the session has not been granted authorization privileges and/or many attempts to access a wide variety of resources. In some examples, such behavior is indicative of a party gaining unapproved access to a user identity or session and attempting to determine the extent of granted privileges.

In some examples, the privilege usage rules are defined to detect suboptimal operation performance or erroneous operation performance during a session based on the authorization checks associated therewith. Such privilege usage rules are defined to detect privilege usage patterns that are suboptimal or otherwise known to be inefficient. In an example, a suboptimal privilege usage pattern includes authorization checks that are unnecessary such as checks to access resources that are not used and/or authorization checks that are redundant such as checks that are performed multiple times during operations when a single authorization check is sufficient. Additionally, or alternatively, the suboptimal privilege usage patterns include patterns of authorization checks associated with known suboptimal operations and/or workflows of operations (e.g., if a workflow for creating a VM has been improved through updated system software enabling fewer authorization checks, a known suboptimal workflow is one that uses the previous workflow for creating a VM, which can be detected based on the authorization checks used during the workflow). If privilege usage patterns of a session are detected that match these suboptimal privilege usage patterns, a suboptimal pattern notification is generated. Such a suboptimal pattern notification includes information describing the suboptimal pattern that is occurring and/or a recommendation for how to alter the pattern to improve the operation of the session. The suboptimal pattern notification is provided to a user of the system for viewing and/or stored or logged for later viewing.

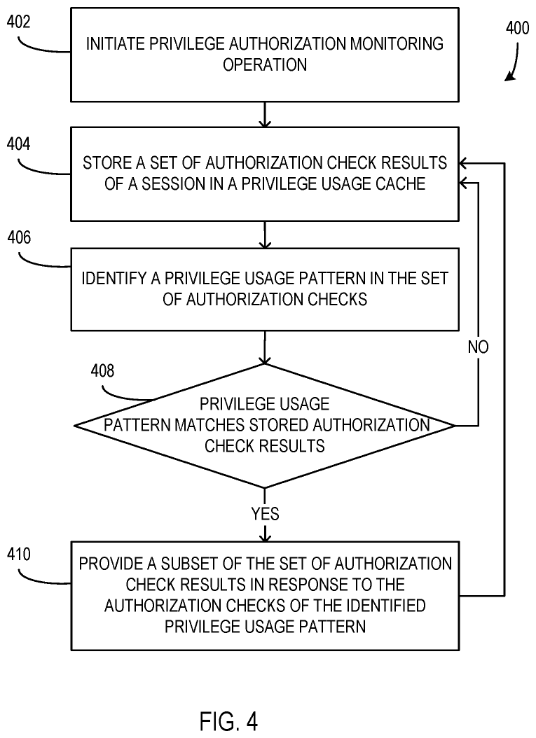

FIG. 4 is a flowchart illustrating a computerized method 400 for storing authorization check results (e.g., in association with cached usage patterns 230) and providing stored results in response to authorization checks (e.g., authorization checks 206). In some examples, the method 400 is executed or otherwise performed in a system such as systems 100 and 200 of FIGS. 1 and 2 respectively. At 402, a privilege authorization monitoring operation is initiated and, at 404, a set of authorization check results of a session are stored in a privilege usage cache of the system. In some examples, the set of authorization check results is updated over time during the operation of the session. Further, authorization check results that are associated with the same privilege as older stored authorization check results are used to overwrite those corresponding older stored authorization check results, such that the privilege usage cache includes only one entry for each privilege authorization check.

At 406, a privilege usage pattern is identified in a current set of authorization checks that have been collected. In some examples, these authorization checks have not been responded to by the authorization module. Between the time of receiving the authorization checks and the time when the authorization module completes the authorization processing, the privilege authorization monitor is configured to perform method 400 as described herein.

At 408, if the privilege usage pattern matches stored authorization check results, the process proceeds to 410. Alternatively, if the privilege usage pattern does not match the stored authorization check results, the process returns to 404 to continue storing authorization check results of the session. In some examples, the authorization checks of the privilege usage pattern are compared to the stored authorization check results and, if results for all the authorization checks are present, the privilege usage pattern is considered to match the stored authorization check results. However, some of the authorization checks do not have corresponding stored results in the privilege usage cache, the privilege usage pattern is considered to not match the authorization check results.

At 410, a subset of the set of authorization check results is provided in response to the authorization checks of the identified privilege usage pattern. In some examples, the subset of results is provided to the authorization module of the system such that the authorization module uses the subset of results to respond to the authorization checks and/or provide access to the session from which the authorization checks were received. In such examples, performing the authorization processing of the authorization module each time an authorization check is received is relatively resource-intensive compared to accessing the privilege usage cache of the privilege authorization module, so using the stored results improves the efficiency of the system.

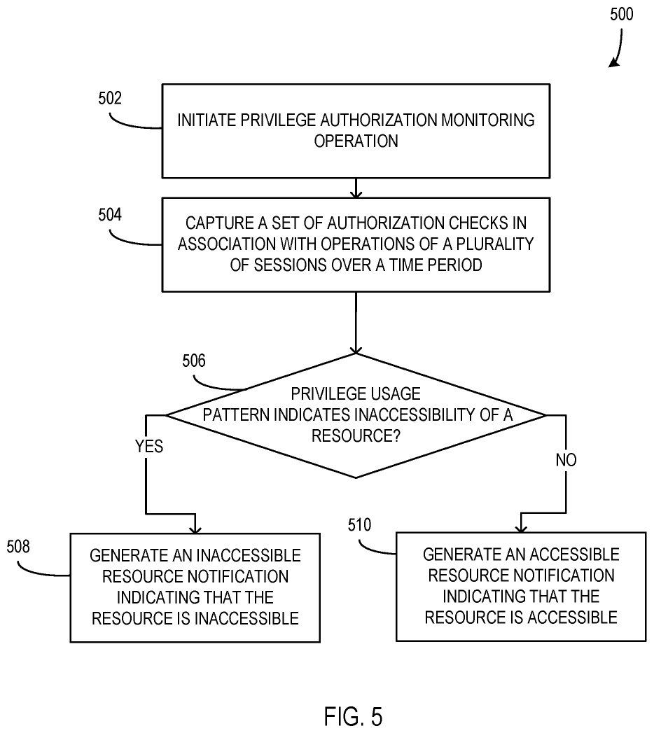

FIG. 5 is a flowchart illustrating a computerized method 500 for monitoring authorization checks (e.g., authorization checks 206) and identifying inaccessible resources (e.g., system resources 210) based on the authorization checks. In some examples, the method 500 is executed or otherwise performed in a system such as systems 100 and 200 of FIGS. 1 and 2 respectively. At 502, a privilege authorization monitoring operation is initiated and, at 504, a set of authorization checks is captured in association with operations of a plurality of sessions over a time period.

At 506, if a privilege usage pattern of the captured set of authorization checks indicates inaccessibility of a resource, the process proceeds to 508. Alternatively, if the privilege usage pattern indicates that the resource is accessible, the process proceeds to 510. In some examples, the privilege usage pattern of set of authorization checks indicates that a resource is inaccessible when the resource is not accessed over the time period. For instance, if the privilege usage pattern includes no authorization checks associated with requests to access the resource of if the privilege usage pattern includes authorization checks associated with the resource but all the of the checks are denied by the system. In such examples, inaccessibility of a resource is due to a privilege to access the resource not being granted to sessions, users, or user roles properly, due to code of the system failing to reference the resource properly, and/or due to other issues.

At 508, an inaccessible resource notification is generated that indicates that the resource is inaccessible. The notification includes an identifier of the resource. Further, in some examples, the notifier includes other information about the resource and the captured set of authorization checks, such as identifiers of privileges associated with the resource, date and time information associated with the captured authorization checks, version information of the software of the system, or the like. The notification is provided to a user of the system and/or stored or logged for future review.

At 510, an accessible resource notification is generated that indicates that the resource is accessible. The notification includes an identifier of the resource. Further, in some examples, the notification includes similar information as described above with respect to the inaccessible resource notification. Additionally, the accessible resource notification is provided to a user for viewing and/or stored or logged for future review.

### Additional Examples

In an example, a user accesses a session on a computing environment. The user attempts to use the session to create a VM on the computing environment. The user's system communicates with the authorization module of the computing environment during the session to request access to the system resources that are needed to create the VM. For instance, an operation during the session requests access to a host device, access to a datastore, and access to some other devices of the computing environment that are to be used for the VM.

The privilege authorization monitor of the computing environment captures the authorization checks sent during the session to the authorization module, in addition to other session data, such as identifiers of the session and the user, the set of privileges granted to a user of the session, and minimum required privileges per operation being performed during the session. The privilege authorization monitor analyzes the session data to detect any usage discrepancies and/or other usage patterns.

The authorization module determines that the user's session has the correct privileges to create the VM and the operations of the session are provided access to the system resources requested. The privilege authorization monitor captures this result and stores the results as part of a cached usage pattern for creating a VM. Further, the monitor determines that the session has several privileges that are not used for creating a VM. However, while these unused privileges may eventually be considered to be excess privileges, the monitor is configured with privilege usage rules that indicate collection of more session data before determining them to be usage discrepancies.

In a related example, the user continues using the session to create several more VMs on the computing environment. When an operation of the session requests access to the system resources for creating a VM, the monitor captures the associated authorization checks and detects behavior that matches the cached usage pattern associated VM creation. In response, the monitor provides the cached authorization check results to the authorization module such that the module does not need to complete conventional authorization processing. The cached results of the cached usage pattern are used to complete the authorization processing for each of the several VMs.

Further, the user continues to use the session to perform operations on the computing environment, including interacting with a GUI. Upon interacting with the GUI, it is redrawn, prompting an operation of the session to request access to all the system resources associated with the GUI repeatedly. The authorization checks of redrawing the GUI are stored by the monitor as a cached usage pattern, which is then use on future redraw operations, speeding up the redrawing of the GUI substantially.

After the user has used the session for some time, the monitor analyzes the privileges used during the session and compares those to the privileges granted to a user of the session. Several excess privileges are detected and, based on the quantity of session data collected, they are determined to be usage discrepancies. The monitor generates a discrepancy notification that identifies the session, and the user has having excess privileges granted and the notification is sent to a system administrator portion of the system where it is viewed by an administrator. The administrator is provided a GUI with which they can interact with the discrepancy notification and view the activity of the session and/or user as well as the granted privileges. Further, the administrator is enabled to easily adjust the privileges granted to a user of the session to eliminate the excess privileges. This increases the security of the system and does not affect the user's experience with the session, as the removed privileges have thus far gone unused, and it has been determined that they are unlikely to be used.

Further, in an example, the privilege authorization monitor of the system includes an API that enables a user to retrieve stored data associated with captured authorization checks. The API enables the user to obtain data sets of authorization checks and associated privilege data based on provided criteria. For instance, the user provides a user identifier, and the API returns a data set of authorization checks associated with that user identifier. The data set further includes privileges associated with the authorization checks and/or information indicative of the associated minimum required privileges for operations. In other examples, other criteria include session identifiers, date and/or time ranges, system resource identifiers, system resource types, or the like. The API enables a user to view a variety of subsets of authorization checks and/or associated privileges based on selected criteria. Additionally, or alternatively, the privilege authorization monitor is configured to enable a user to retrieve the stored authorization check data such that the user can analyze the data outside of the privilege authorization monitor.

In an example, the privilege authorization monitor provides an administrator or other user access to APIs. The APIs include an API for monitoring all authorization checks in the computing environment such that the user can audit how the system is used, an API to retrieve the latest authorization checks matching specific criteria such that the user can set up privileges according to the principle of minimum required privileges, an API to start recording the authorization checks made in the computing environment and an API to stop recording the authorization checks made in the computing environment such that the user can control when the system is monitored.

Further, in an example, the APIs include an API that enables the user to provide a user identifier, a session identifier, and/or an operation identifier and the API retrieves authorization check data associated with the provided identifier(s). Additionally, or alternatively, the APIs include an API that retrieves authorization checks as they occur in real-time or near real-time. The retrieved authorization checks of this API are further filtered or otherwise controlled based on criteria if the user provides such criteria.

### Exemplary Operating Environment

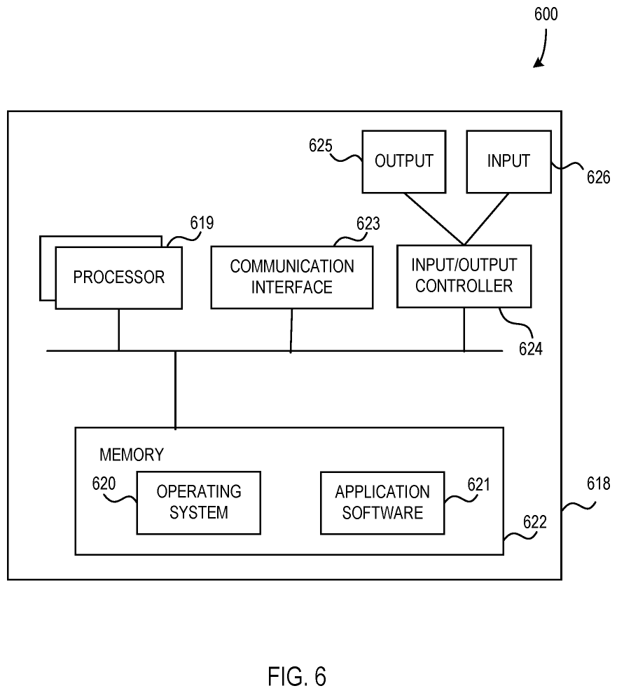

The present disclosure is operable with a computing apparatus as a functional block diagram 600 in FIG. 6. In an embodiment, components of a computing apparatus 618 is implemented as a part of an electronic device according to one or more embodiments described in this specification. The computing apparatus 618 comprises one or more processors 619 (e.g., microprocessors, controllers, and/or any other suitable type of processors for processing computer executable instructions to control the operation of the electronic device). Alternatively, or in addition, the processor 619 is any technology capable of executing logic or instructions, such as a hardcoded machine. Platform software comprising an operating system 620 or any other suitable platform software is provided on the apparatus 618 to enable application software 621 to be executed on the device. According to an embodiment, monitoring authorization checks and detecting excess authorization privileges and other privilege usage patterns as described herein is accomplished by software, hardware, and/or firmware.

In some examples, computer executable instructions are provided using any computer-readable media that are accessible by the computing apparatus 618. Computer-readable media includes, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media embodies computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which is separate from or integral to the electronic device. The input/output controller 624 is also be configured to receive and process an input from one or more input devices 626, for example, a keyboard, a microphone, or a touchpad. In one embodiment, the output device 625 also acts as the input device. An example of such a device is a touch sensitive display. The input/output controller 624 also outputs data to devices other than the output device, e.g., a locally connected printing device. In some embodiments, a user provides input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

In some examples, at least a portion of the functionality of the various elements in the figures are performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions are organized into one or more computer-executable components or modules. Generally, program modules include, but are not limited to, routines, programs, objects, components, and data structures that perform particular tasks or implement particular abstract data types. Aspects of the disclosure are implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor; at least one memory comprising computer program code, the at least one memory and the computer program code configured to, with the at least one processor, cause the at least one processor to: capture an authorization check associated with an operation performed during a session in a computing environment, wherein the authorization check is triggered by the operation invoking an application program interface (API) to access a resource of the computing environment; identify a set of authorization privileges granted to a user of the session; compare the identified set of authorization privileges to a set of authorization checks associated with the session including the captured authorization check; detect based on the comparison of the set of authorization privileges to the set of authorization checks, a set of excess authorization privileges granted to the user of the session, the set of excess authorization privileges being a subset of the identified set of authorization privileges; and generate a privilege discrepancy notification based on the detected set of excess authorization privileges.

An example method comprises: capturing an authorization check associated with an operation performed during a session in a computing environment, wherein the authorization check is triggered by the operation invoking an application program interface (API) to access a resource of the computing environment; identifying a set of authorization privileges granted to a user of the session; comparing the identified set of authorization privileges to a set of authorization checks associated with the session including the captured authorization check; detecting based on the comparison of the set of authorization privileges to the set of authorization checks, a set of excess authorization privileges granted to the user of the session, the set of excess authorization privileges being a subset of the identified set of authorization privileges; and generating a privilege discrepancy notification based on the detected set of excess authorization privileges.

One or more computer storage media have computer-executable instructions that, upon execution by a processor, cause the processor to at least: capture an authorization check associated with an operation performed during a session in a computing environment, wherein the authorization check is triggered by the operation invoking an application program interface (API) to access a resource of the computing environment; identify a set of authorization privileges granted to a user of the session; compare the identified set of authorization privileges to a set of authorization checks associated with the session including the captured authorization check; detect based on the comparison of the set of authorization privileges to the set of authorization checks, a set of excess authorization privileges granted to the user of the session, the set of excess authorization privileges being a subset of the identified set of authorization privileges; and generate a privilege discrepancy notification based on the detected set of excess authorization privileges.

Alternatively, or in addition to the other examples described herein, examples include any combination of the following:
further comprising: capturing the set of authorization checks in association with operations during a plurality of sessions associated with a user; wherein the generated discrepancy notification identifies the user as being granted the set of excess authorization privileges.
further comprising: storing a set of authorization check results of the session in a privilege usage cache; identifying a privilege usage pattern in the set of authorization checks; and providing a subset of the set of authorization check results in response to authorization checks of the identified privilege usage pattern, wherein the subset of authorization check results corresponds to the authorization checks of the identified privilege usage pattern.
further comprising: detecting based on a privilege usage rule, a privilege usage pattern in the set of authorization checks, wherein the privilege usage rule indicates performance of a malicious operation during the session; and generating based on the detected privilege usage pattern, a malicious operation notification indicating the malicious operation is being performed during the session.
further comprising: capturing the set of authorization checks in association with operations performed during a plurality of sessions over a time period; detecting based on a privilege usage rule, a privilege usage pattern in the captured set of authorization checks, wherein the privilege usage rule indicates inaccessibility of a resource of the computing environment due to granted privileges; and generating based on the detected privilege usage pattern, an inaccessible resource notification indicating a resource that is inaccessible.
further comprising: detecting based on a privilege usage rule, a privilege usage pattern in the set of authorization checks, wherein the privilege usage rule indicates a suboptimal privilege usage pattern for performing an operation and the detected privilege usage pattern matches the suboptimal privilege usage pattern, wherein the suboptimal privilege pattern includes at least one of the following: an unnecessary authorization check or a redundant authorization check; and generating based on the detected privilege usage pattern, a suboptimal pattern notification indicating performance of a suboptimal operation during the session.
wherein the set of authorization checks are associated with requests for access to resources of the computing environment; and wherein the resources of the computing environment include at least one of the following: processing resources and data storage resources.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. Additionally, or alternatively, the consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above relate to one embodiment or relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for capturing an authorization check associated with an operation performed during a session of a user in a computing environment, wherein the authorization check is triggered by the operation invoking an application program interface (API) to access a resource of the computing environment; exemplary means for identifying a set of authorization privileges granted to the user during the session; exemplary means for comparing the identified set of authorization privileges to a set of authorization checks associated with the session including the captured authorization check; exemplary means for detecting based on the comparison of the set of authorization privileges to the set of authorization checks, a set of excess authorization privileges granted to the user during the session, the set of excess authorization privileges being a subset of the identified set of authorization privileges; and exemplary means for generating a privilege discrepancy notification based on the detected set of excess authorization privileges.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method performed by a processor, the method comprising:
capturing an authorization check associated with an operation, the operation being performed during a session in a computing environment, wherein the authorization check is triggered by the operation invoking an application program interface (API) to access a resource of the computing environment;
identifying a set of authorization privileges granted to a user of the session;
comparing the identified set of authorization privileges to a set of authorization checks associated with the session including the captured authorization check;
detecting, based on the comparison of the set of authorization privileges to the set of authorization checks, a set of excess authorization privileges granted to the user of the session, the set of excess authorization privileges being a subset of the identified set of authorization privileges; and
generating a privilege discrepancy notification based on the detected set of excess authorization privileges.

2. The method of claim 1, further comprising:
capturing the set of authorization checks in association with operations during a plurality of sessions associated with the user; and
wherein the generated discrepancy notification identifies the user as being granted the set of excess authorization privileges.

3. The method of claim 1, further comprising:
storing a set of authorization check results of the session in a privilege usage cache;
identifying a privilege usage pattern in the set of authorization checks; and
providing a subset of the set of authorization check results in response to authorization checks of the identified privilege usage pattern, wherein the subset of authorization check results corresponds to the authorization checks of the identified privilege usage pattern.

4. The method of claim 1, further comprising:
detecting, based on a privilege usage rule, a privilege usage pattern in the set of authorization checks, wherein the privilege usage rule indicates performance of a malicious operation during the session; and
generating, based on the detected privilege usage pattern, a malicious operation notification indicating the malicious operation is being performed during the session.

5. The method of claim 1, further comprising:
capturing the set of authorization checks in association with operations performed during a plurality of sessions over a time period;
detecting, based on a privilege usage rule, a privilege usage pattern in the captured set of authorization checks, wherein the privilege usage rule indicates inaccessibility of a resource of the computing environment due to granted privileges; and
generating, based on the detected privilege usage pattern, an inaccessible resource notification indicating a resource that is inaccessible.

6. The method of claim 1, further comprising:
detecting based on a privilege usage rule, a privilege usage pattern in the set of authorization checks, wherein the privilege usage rule indicates a suboptimal privilege usage pattern for performing an operation and the detected privilege usage pattern matches the suboptimal privilege usage pattern, wherein the suboptimal privilege pattern includes at least one of the following: an unnecessary authorization check or a redundant authorization check; and
generating based on the detected privilege usage pattern, a suboptimal pattern notification indicating performance of a suboptimal operation during the session.

7. The method of claim 1, wherein the set of authorization checks are associated with requests for access to resources of the computing environment; and
wherein the resources of the computing environment include at least one of the following: processing resources and data storage resources.

8. A system comprising:
at least one processor;
at least one memory comprising computer program code, the at least one memory and the computer program code configured to, with the at least one processor, cause the at least one processor to:
capture an authorization check associated with an operation, the operation being performed during a session in a computing environment, wherein the authorization check is triggered by the operation invoking an application program interface (API) to access a resource of the computing environment;
identify a set of authorization privileges granted to a user of the session;
compare the identified set of authorization privileges to a set of authorization checks associated with the session including the captured authorization check;
detect based on the comparison of the set of authorization privileges to the set of authorization checks, a set of excess authorization privileges granted to the user of the session, the set of excess authorization privileges being a subset of the identified set of authorization privileges; and
generate a privilege discrepancy notification based on the detected set of excess authorization privileges.

9. The system of claim 8, wherein the at least one memory and the computer program code are configured to, with the at least one processor, further cause the at least one processor to:
capture the set of authorization checks in association with operations during a plurality of sessions associated with the user; and
wherein the generated discrepancy notification identifies the user as being granted the set of excess authorization privileges.

10. The system of claim 8, wherein the at least one memory and the computer program code are configured to, with the at least one processor, further cause the at least one processor to:
store a set of authorization check results of the session in a privilege usage cache;
identify a privilege usage pattern in the set of authorization checks; and
provide a subset of the set of authorization check results in response to authorization checks of the identified privilege usage pattern, wherein the subset of authorization check results corresponds to the authorization checks of the identified privilege usage pattern.

11. The system of claim 8, wherein the at least one memory and the computer program code are configured to, with the at least one processor, further cause the at least one processor to:
detect, based on a privilege usage rule, a privilege usage pattern in the set of authorization checks, wherein the privilege usage rule indicates performance of a malicious operation during the session; and
generate, based on the detected privilege usage pattern, a malicious operation notification indicating the malicious operation is being performed during the session.

12. The system of claim 8, wherein the at least one memory and the computer program code are configured to, with the at least one processor, further cause the at least one processor to:
capture the set of authorization checks in association with operations performed during a plurality of sessions over a time period;
detect based on a privilege usage rule, a privilege usage pattern in the captured set of authorization checks, wherein the privilege usage rule indicates inaccessibility of a resource of the computing environment due to granted privileges; and
generate based on the detected privilege usage pattern, an inaccessible resource notification indicating a resource that is inaccessible.

13. The system of claim 8, wherein the at least one memory and the computer program code are configured to, with the at least one processor, further cause the at least one processor to:
detect, based on a privilege usage rule, a privilege usage pattern in the set of authorization checks, wherein the privilege usage rule indicates a suboptimal privilege usage pattern for performing an operation and the detected privilege usage pattern matches the suboptimal privilege usage pattern, wherein the suboptimal privilege pattern includes at least one of the following: an unnecessary authorization check or a redundant authorization check; and
generate, based on the detected privilege usage pattern, a suboptimal pattern notification indicating performance of a suboptimal operation during the session.

14. The system of claim 8, wherein the set of authorization checks are associated with requests for access to resources of the computing environment; and
wherein the resources of the computing environment include at least one of the following: processing resources and data storage resources.

15. One or more computer storage media having computer-executable instructions that, upon execution by a processor, cause the processor to at least:
capture an authorization check associated with an operation, the operation being performed during a session in a computing environment, wherein the authorization check is triggered by the operation invoking an application program interface (API) to access a resource of the computing environment;
identify a set of authorization privileges granted to a user of the session;
compare the identified set of authorization privileges to a set of authorization checks associated with the session including the captured authorization check;
detect based on the comparison of the set of authorization privileges to the set of authorization checks, a set of excess authorization privileges granted to the user of the session, the set of excess authorization privileges being a subset of the identified set of authorization privileges; and
generate a privilege discrepancy notification based on the detected set of excess authorization privileges.

16. The one or more computer storage media of claim 15, wherein the computer-executable instructions, upon execution by a processor, further cause the processor to at least:
capture the set of authorization checks in association with operations during a plurality of sessions associated with the user; and
wherein the generated discrepancy notification identifies the user as being granted the set of excess authorization privileges.

17. The one or more computer storage media of claim 15, wherein the computer-executable instructions, upon execution by a processor, further cause the processor to at least:
store a set of authorization check results of the session in a privilege usage cache;
identify a privilege usage pattern in the set of authorization checks; and
provide a subset of the set of authorization check results in response to authorization checks of the identified privilege usage pattern, wherein the subset of authorization check results corresponds to the authorization checks of the identified privilege usage pattern.

18. The one or more computer storage media of claim 15, wherein the computer-executable instructions, upon execution by a processor, further cause the processor to at least:
detect, based on a privilege usage rule, a privilege usage pattern in the set of authorization checks, wherein the privilege usage rule indicates performance of a malicious operation during the session; and
generate, based on the detected privilege usage pattern, a malicious operation notification indicating the malicious operation is being performed during the session.

19. The one or more computer storage media of claim 15, wherein the computer-executable instructions, upon execution by a processor, further cause the processor to at least:
capture the set of authorization checks in association with operations performed during a plurality of sessions over a time period;
detect based on a privilege usage rule, a privilege usage pattern in the captured set of authorization checks, wherein the privilege usage rule indicates inaccessibility of a resource of the computing environment due to granted privileges; and
generate based on the detected privilege usage pattern, an inaccessible resource notification indicating a resource that is inaccessible.

20. The one or more computer storage media of claim 15, wherein the computer-executable instructions, upon execution by a processor, further cause the processor to at least:
detect, based on a privilege usage rule, a privilege usage pattern in the set of authorization checks, wherein the privilege usage rule indicates a suboptimal privilege usage pattern for performing an operation and the detected privilege usage pattern matches the suboptimal privilege usage pattern, wherein the suboptimal privilege pattern includes at least one of the following: an unnecessary authorization check or a redundant authorization check; and
generate, based on the detected privilege usage pattern, a suboptimal pattern notification indicating performance of a suboptimal operation during the session.
